(19) United States
(12) Patent Application Publication
(10) Pub. No.: US 2023/0382190 A1
(43) Pub. Date: Nov. 30, 2023

(54) HEATER DEVICE

(71) Applicant: DENSO CORPORATION, Kariya-city (JP)

(72) Inventors: Takuya IGASHIRA, Kariya-city (JP); Shuzo ODA, Kariya-city (JP); Yusuke TANAKA, Kariya-city (JP); Yuya SUZUKI, Kariya-city (JP)

(21) Appl. No.: 18/446,191

(22) Filed: Aug. 8, 2023

Related U.S. Application Data
(63) Continuation of application No. PCT/JP22/09441, filed on Mar. 4, 2022.

(30) Foreign Application Priority Data
Mar. 26, 2021 (JP) 2021-053509

(51) Int. Cl. B60H 1/22; H05B 1/02

(52) U.S. Cl. CPC B60H 1/2226; H05B 1/0236; H05B 2203/014; H05B 2203/032

(57) ABSTRACT

A heater device includes an insulating base material, a heater wire, a temperature detection element, a line and a branch line. The heater wire is provided on the insulating base material, forms a path through which current flows when energized, and generates heat when energized. The temperature detection element is provided on the insulating base material and has an electrical characteristics that change according to temperature. The line is provided on the insulating base material and is electrically connected to the temperature detection element. The branch line is provided on the insulating base material, has one end connected to the heater wire and the other end not connected to the heater wire, and extends around the temperature detection element.

### CROSS REFERENCE TO RELATED APPLICATIONS

The present application is a continuation application of International Patent Application No. PCT/JP2022/009441 filed on Mar. 4, 2022, which designated the U.S. and claims the benefit of priority from Japanese Patent Application No. 2021-053509 filed on Mar. 26, 2021, the entire disclosure of the above application is incorporated herein by reference.

### TECHNICAL FIELD

The present disclosure relates to a heater device.

### BACKGROUND

Conventionally, there has been known a heater device that is mounted on a vehicle and warms an occupant by radiating radiant heat to the occupant.

### SUMMARY

An object of the present disclosure is to improve an accuracy of temperature detection by a temperature detection element without increasing a resistance of a heater wire in a heater device.

According to one aspect of the present disclosure, a heater device includes an insulating base material, a heater wire, a temperature detection element, a line, and a branch line. The heater wire is provided on the insulating base material, forms a path through which current flows when energized, and generates heat when energized. The temperature detection element is provided on the insulating base material, and has its electrical characteristics that changes according to the temperature. The line is provided on the insulating base material and electrically connected to the temperature detection element. The branch line is provided on the insulating base material, has one end connected to the heater wire and the other end not connected to the heater wire, and extends around the temperature detection element.

### BRIEF DESCRIPTION OF DRAWINGS

FIG. 1 is a diagram illustrating a state in which a heater device is mounted on a vehicle in a first embodiment;

FIG. 2 is a plan view showing the heater device according to the first embodiment;

FIG. 3 is a cross-sectional view taken along the line III-III of FIG. 2;

FIG. 4 is an enlarged view of a portion IV of FIG. 2;

FIG. 5 is a plan view showing the heater device according to a second embodiment;

FIG. 6 is an enlarged view of a portion VI of FIG. 5;

FIG. 7 is a plan view showing part of a heater device according to a third embodiment;

FIG. 8 is a plan view showing part of a heater device according to a fourth embodiment;

FIG. 9 is a plan view showing part of a heater device according to a fifth embodiment;

FIG. 10 is a plan view showing part of a heater device of a first comparative example;

FIG. 11 is a plan view showing part of a heater device of a second comparative example; and

FIG. 12 is a plan view showing part of a heater device of a third comparative example.

### DETAILED DESCRIPTION

In an assumable example, there has been known a heater device that is mounted on a vehicle and warms an occupant by radiating radiant heat to the occupant. The heater device is a planar heater including a heater wire provided on a substrate, a chip thermistor as a temperature detection element for detecting the temperature of heat generated by the heater wire, and a thermistor line as wiring for transmitting a detection signal of the chip thermistor or the like. In this heater device, the heater wire and the thermistor line are formed on a predetermined surface of the substrate by etching a metal foil attached on the substrate, and the chip thermistor is installed on the thermistor line. Accordingly, it is possible to manufacture a thin planar heater having a temperature detection function.

However, in the heater device, the heater wire is arranged to avoid the chip thermistor and the thermistor line in the predetermined surface of the substrate, so there are areas where the chip thermistor and the heater wire are far apart. As a result, the difference between the temperature of the chip thermistor and the temperature of heat generated by the heater wire becomes large, and there is a problem that the detection accuracy of the temperature of heat generated by the heater wire by the chip thermistor deteriorates. When the temperature detection accuracy of the chip thermistor deteriorates, when the controller of the heater device controls the energization of the heater wire based on the temperature detected by the chip thermistor to control the temperature of the planar heater, a problem arises that the response speed of the temperature control is lowered.

By the way, in order to solve the above problem, it is conceivable to extend and run the heater wire around the chip thermistor in an area where the temperature difference between the chip thermistor and the heater wire is large. However, since a total length of the heater wire increases and a resistance value of the heater wire increases, there arises a problem that the heating speed of the planar heater becomes slow when the heater wire is energized.

An object of the present disclosure is to improve an accuracy of temperature detection by a temperature detection element without increasing a resistance of a heater wire in a heater device.

According to one aspect of the present disclosure, a heater device includes an insulating base material, a heater wire, a temperature detection element, a line, and a branch line. The heater wire is provided on the insulating base material, forms a path through which current flows when energized, and generates heat when energized. The temperature detection element is provided on the insulating base material, and has its electrical characteristics that changes according to the temperature. The line is provided on the insulating base material and electrically connected to the temperature detection element. The branch line is provided on the insulating base material, has one end connected to the heater wire and the other end not connected to the heater wire, and extends around the temperature detection element.

According to this configuration, when the heater wire generates heat by energizing the heater wire, the heat is transmitted to the branch line. Since the branch wire extends around the temperature detection element, the temperature of the temperature detection element is raised by the heat of the heater wire and the branch line, and the temperature of the heat generating surface (that is, the surface where the heater wire is arranged on the insulating base material) of the heater device is detected. Therefore, even if there is a place where the distance between the heater wire and the temperature detection element is longer, by arranging the branch line around the temperature detection element, it is possible to reduce the difference between the heating temperature of the heater wire and the temperature of the temperature detection element. Therefore, the heater device can improve the temperature detection accuracy of the heat generating surface by the temperature detection element and improve the response speed of the temperature control of the heater wire.

Further, according to this configuration, since the heater wire does not extend around the temperature detecting element, the total length of the heater wire does not become long. Therefore, the resistance value of the heater wire does not increase, and a decrease in the rate of temperature increase when the heater wire is energized can be prevented.

Embodiments of the present disclosure will now be described with reference to the drawings. In the following embodiments, the same or equivalent parts are denoted by the same reference numerals as each other, and explanations will be provided to the same reference numerals. The terms “upper”, “lower”, “left”, and “right” used in the following description and drawings are used for convenience of explanation, and do not limit the usage conditions of the heater device.

### First Embodiment

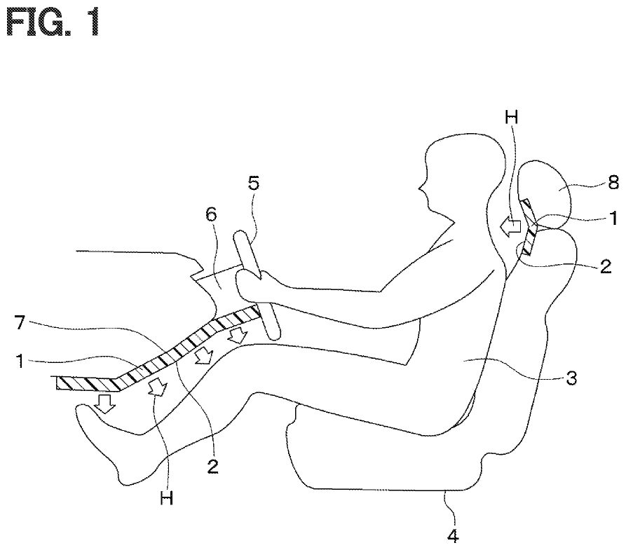

A heater device according to the first embodiment will be described. As shown in FIG. 1, a heater device 1 is installed in an interior of a moving body such as a vehicle. The heater device 1 constitutes a part of a heating device in a vehicle interior. The heater device 1 is an electric heater that is supplied with a power from a power supply such as a battery and a generator mounted on the moving body to generate heat. The heater device 1 is a planar heater formed in a flexible thin plate shape. The heater device 1 has a heat generating surface 2 that generates heat when electric power is supplied, and radiates radiant heat H mainly in a direction perpendicular to the heat generating surface 2. The heater device 1 is used to heat an object positioned in a direction perpendicular to the heat generating surface 2.

The heater device 1 can be used, for example, as a device for promptly providing warmth to an occupant 3 immediately after the vehicle running engine is started. The heater device 1 is installed so as to radiate radiant heat H at the feet and neck of the occupant 3 seated on a seat 4 in the vehicle interior. Specifically, the heater device 1 is installed, for example, on a lower surface of a steering column cover 6 provided to cover a steering column for supporting a steering 5, on a dashboard 7 located below the steering column cover 6, or on a headrest 8 of the seat 4, or the like. Since the heater device 1 has flexibility, it is installed along each mounting surface.

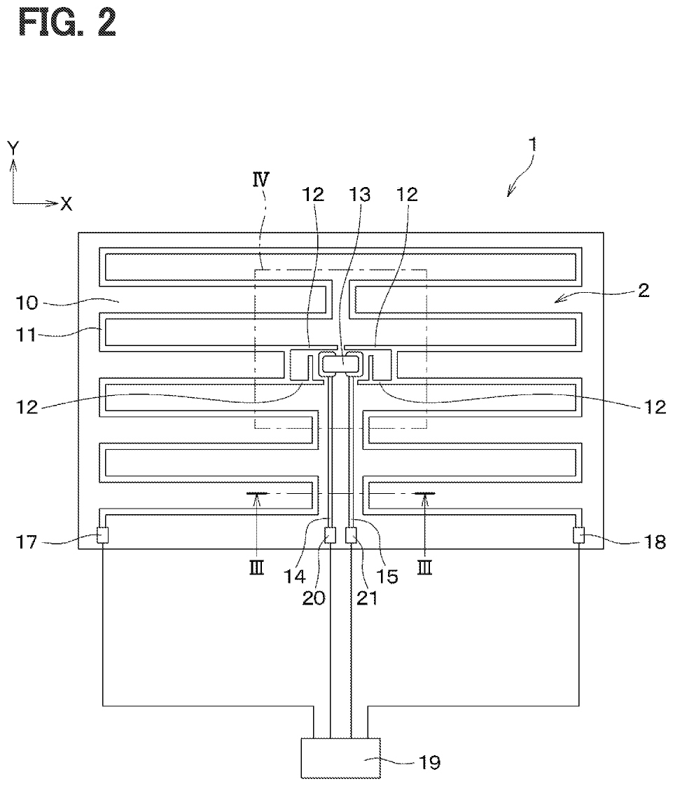

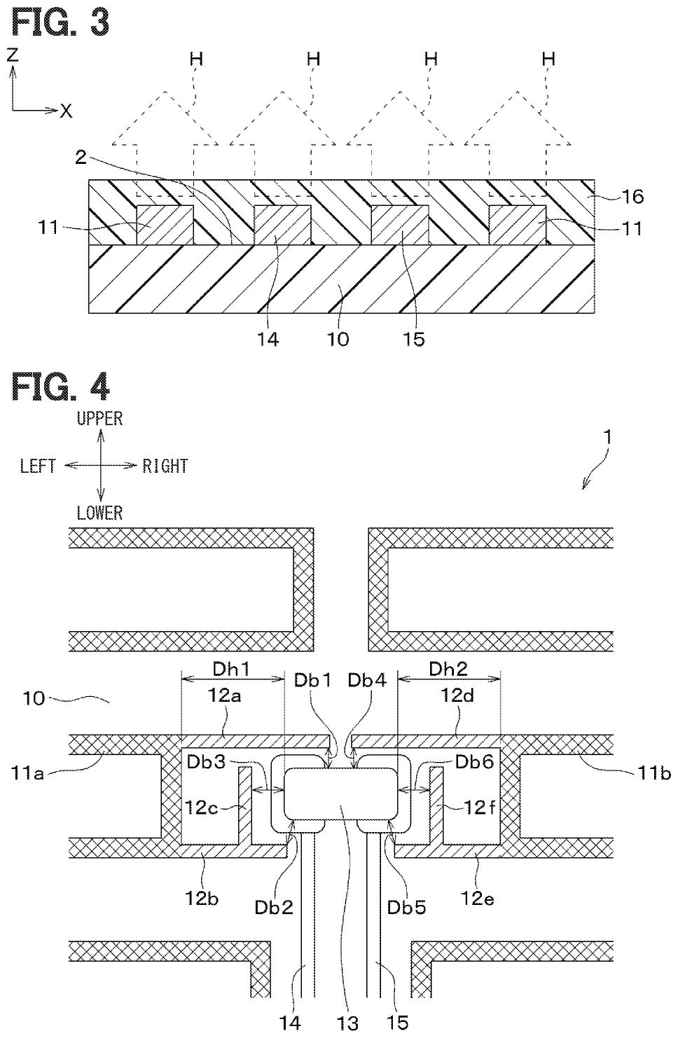

FIG. 2 is a plan view of the heater device 1. In this state, the heater device 1 extends along a X-Y plane defined by an axis X and an axis Y. FIG. 3 is a cross-sectional view taken along line Ill-Ill of FIG. 2. As shown in FIG. 3, the heater device 1 has a thickness in the direction of the axis Z, and radiates radiant heat H in a direction perpendicular to the surface as indicated by the dashed arrows.

As shown in FIGS. 2 to 4, the heater device 1 includes an insulating base material 10, a heater wire 11, a branch line 12, a chip thermistor 13 as a temperature detection element, thermistor lines 14 and 15 as wiring, an insulating layer 16, and the like. The heater wire 11, the branch line 12, the chip thermistor 13 and thermistor lines 14 and 15 are arranged on one surface of the insulating base material 10 and covered with the insulating layer 16.

FIGS. 2 and 4 are views seen through the insulating layer 16. In FIG. 4, in order to distinguish between the heater wire 11 and the branch line 12, although it is not a cross sectional view, the heater wire 11 is shown with cross hatching, and the branch line 12 is shown with oblique hatching. This view also applies to FIGS. 6 to 12 and 14, which are referred to in each embodiment and comparative example described later. Further, in FIG. 4, for convenience of explanation, in order to distinguish the parts of the plurality of branch lines 12 and the heater wires 11, alphabets are attached to the end of the reference numerals indicating each of branch lines 12 and heater wires 11.

The insulating base material 10 is made of a resin material (for example, a polyimide film) that has excellent electrical insulation and is resistant to high temperatures. Moreover, the insulating base material 10 is made of a flexible material.

The heater wire 11 is formed of a thin film of a metal material (for example, copper or silver) that has high thermal conductivity and generates heat when energized. As shown in FIG. 2, the heater wire 11 is provided linearly or curvedly on a predetermined surface of the insulating base material 10 to form a path through which current flows when energized. Specifically, the heater wire 11 is folded back at predetermined intervals so as to meander on a predetermined surface of the insulating base material 10. Terminals 17 and 18 provided at both ends of the heater wire 11 are connected to a controller 19.

The controller 19 includes a microcontroller having a processor for performing control processing and arithmetic processing, and a storage unit, such as a ROM and a RAM, for storing programs and data. The controller also includes peripheral circuits for these components. When a current flows through the heater wire 11 due to energization control by the controller 19, the heater wire 11 generates heat. A predetermined surface of the heater device 1 on which the heater wire 11 is arranged on the insulating base material 10 functions as the heat generating surface 2.

The chip thermistor 13 is a temperature detection element whose electrical characteristics (specifically, resistance value) change according to temperature. The two thermistor lines 14 and 15 are wiring electrically connected to two electrodes of the chip thermistor 13, respectively. Terminals 20 and 21 provided at the ends of the thermistor lines 14 and 15 opposite to the chip thermistor 13 are connected to the controller 19. The controller 19 energizes the chip thermistor 13 from the thermistor lines 14 and 15 and detects the temperature of the heat generating surface 2 from the change in the resistance value of the chip thermistor 13.

As described above, the chip thermistor 13 and the thermistor lines 14 and 15, like the heater wire 11, are provided on a predetermined surface (that is, the heat generating surface 2) of the insulating base material 10. Therefore, the heater wire 11 is arranged on a predetermined surface (that is, the heat generating surface 2) of the insulating base material 10 so as to avoid the chip thermistor 13 and the thermistor lines 14 and 15.

The branch lines 12 are made of a metal material having a high thermal conductivity (for example, copper or silver) and extends around the chip thermistor 13 in the same manner as the heater wire 11. One end of the branch line 12 is connected to the heater wire 11. That is, the branch line 12 and the heater wire 11 are continuously formed as a thin film of the same material. Therefore, the heat generated by the heater wire 11 is transmitted to the branch line 12 with high efficiency. On the other hand, the other end of the branch line 12 is not connected to the heater wire 11. Therefore, when the heater wire 11 is energized, the branch line 12 is excluded from the path through which the current flows, so the resistance value of the heater wire 11 does not change. Since the branch line 12 extends around the chip thermistor 13, the heat transmitted from the heater wire 11 can raise the temperature of the chip thermistor 13.

The branch line 12 included in the heater device 1 of the first embodiment will be described in detail below with reference to FIG. 4. In the first embodiment, the plurality of branch lines 12 shown in FIG. 4 are referred to as first to sixth branch lines 12a to 12f, and the symbols indicating each of the branch lines 12 are suffixed with an alphabet. In the following description, for convenience of explanation, terms such as “upper”, “lower”, “left”, and “right” in the paper surface of FIG. 4 to be referred to will be used, and those terms do not limit the state in which the heater device 1 is installed in the vehicle or the like. This explanation also applies to the description of each embodiment and each comparative example that will be described later.

The first branch line 12a approaches the chip thermistor 13 from the heater wire 11a arranged on a left side of a paper surface of FIG. 4, and extends along an upper surface of the chip thermistor 13 (that is, the surface of the chip thermistor 13 on the upper side of the paper surface of FIG. 4). The second branch line 12b extends to approach one thermistor line 14 from the heater wire 11a arranged on a left side of the paper surface of FIG. 4, and extends close to a lower surface of the chip thermistor 13 (that is, the surface of the chip thermistor 13 on the lower side of the paper surface of FIG. 4). The third branch line 12c extends upward from a middle of the second branch line 12b along the left side surface of the chip thermistor 13 (that is, the surface on the left side of the chip thermistor 13 of the paper surface of FIG. 4).

The fourth branch line 12d approaches the chip thermistor 13 from the heater wire 11b arranged on a right side of the paper surface of FIG. 4, and extends along the upper surface of the chip thermistor 13. The fifth branch line 12e extends to approach the other thermistor line 15 from the heater wire 11b arranged on the right side of the paper surface of FIG. 4, and extends close to the lower surface of the chip thermistor 13. The sixth branch line 12f extends upward from a middle of the fifth branch line 12e along the right side surface of the chip thermistor 13 (that is, the surface on the right side of the chip thermistor 13 of the paper surface of FIG. 4). Thus, in the first embodiment, the first to sixth branch lines 12a to 12f are provided so as to surround the chip thermistor 13.

Here, a distance between the heater wire 11 and the chip thermistor 13 is defined as Dh, and a distance between the branch line 12 and the chip thermistor 13 is defined as Db. Specifically, the distance between the heater wire 11a arranged on the left side of the paper surface of FIG. 4 and the left side surface of the chip thermistor 13 is defined as Dh1, and a distance between the heater wire 11b arranged on the right side of the paper surface of FIG. 4 and the right side surface of the chip thermistor 13 is defined as Dh2.

On the other hand, a distance between the first branch line 12a and the chip thermistor 13 is defined as Db1, a distance between the second branch line 12b and the chip thermistor 13 is defined as Db2, and a distance between the third branch line 12c and the chip thermistor 13 is defined as Db3. A distance between the fourth branch line 12d and the chip thermistor 13 is defined as Db4, a distance between the fifth branch line 12e and the chip thermistor 13 is defined as Db5, and the distance between the sixth branch line 12f and the chip thermistor 13 is defined as Db6.

At this time, all of the distances Db1, Db2, and Db3 between the first to third branch lines 12a to 12c and the chip thermistor 13 are shorter than the distance Dh1 between the heater wire 11a arranged on the left side of the paper surface of FIG. 4 and the left side surface of the chip thermistor 13. Further, all of the distances Db4, Db5, and Db6 between the fourth to sixth branch lines 12d to 12f and the chip thermistor 13 are shorter than the distance Dh1 between the heater wire 11b arranged on the right side of the paper surface of FIG. 4 and the right side surface of the chip thermistor 13. That is, the distance Db between the branch line 12 and the chip thermistor 13 is shorter than the distance Dh between the heater wire 11 and the chip thermistor 13. Thus, in the first embodiment, all of the plurality of branch lines 12 are arranged around the chip thermistor 13 at positions closer than the distance Dh between the heater wire 11 and the chip thermistor 13.

In the configuration of the heater device 1 described above, when a predetermined voltage is applied from the controller 19 to the terminal 17 of the heater wire 11 and a potential difference is generated between the terminals 17 and 18, a current flows through the heater wire 11 and the heater wire 11 generates heat. The heater device 1 emits radiant heat that makes the occupant 3 feel warm. At this time, the heat generated by the heater wire 11 is transferred to the branch line 12. Since the branch line 12 extends around the chip thermistor 13, the temperature of the chip thermistor 13 is raised by the heat of the heater wire 11 and the branch line 12. That is, in the first embodiment, since the branch line 12 is arranged around the chip thermistor 13, the temperature difference between the heating temperature of the heater wire 11 and the temperature of the chip thermistor 13 becomes small. The controller 19 detects the temperature of the heat generating surface 2 from the change in the resistance value of the chip thermistor 13. Based on the detected temperature of the heat generating surface 2, the controller 19 performs on/off control or duty control of energization to the heater wire 11 so that the heat generating surface 2 reaches a predetermined target temperature.

Here, a heater device 101 of a first comparative example will be described for comparison with the heater device 1 of the first embodiment described above.

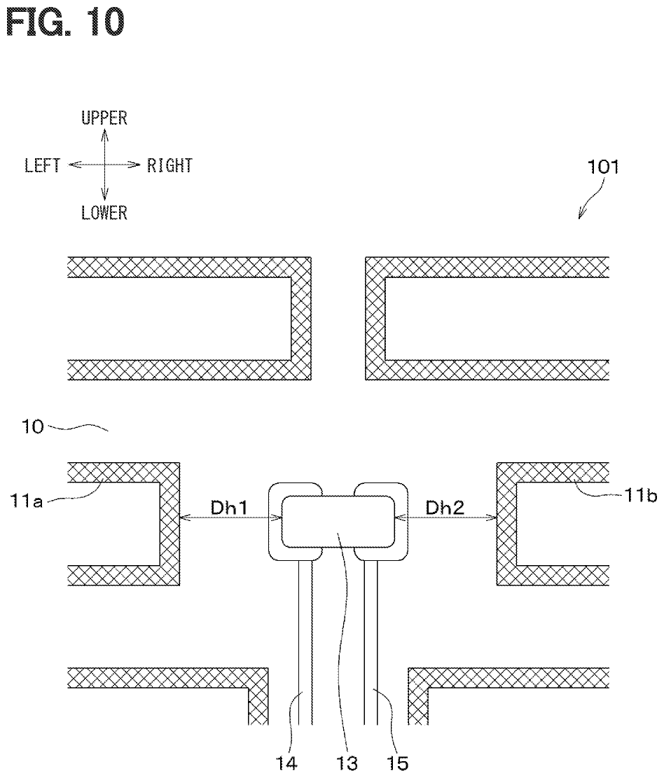

As shown in FIG. 10, the heater device 101 of the first comparative example does not have the branch line 12. Therefore, in the first comparative example, the distances Dh1 and Dh2 between the heater wires 11a and 11b and the chip thermistor 13 are longer than the distances Db1 to Db6 between the branch lines 12a to 12f and the chip thermistor 13 described in the first embodiment.

In the heater device 101 of the first comparative example, when a predetermined voltage is applied from the controller 19 to the terminal 17 of the heater wire 11 and a potential difference is generated between the terminals 17 and 18, a current flows through the heater wire 11 and the heater wire 11 generates heat. However, in the first comparative example, the distances Dh1 and Dh2 between the heater wire 11 and the chip thermistor 13 are longer than the distances Db1 to Db6 between the branch lines 12a to 12f and the chip thermistor 13 described in the first embodiment. Therefore, in the configuration of the first comparative example, the difference between the heating temperature of the heater wire 11 and the temperature of the chip thermistor 13 is greater than that in the first embodiment. Therefore, in the first comparative example, the detection accuracy of the heating temperature of the heater wire 11 deteriorates due to the change in the resistance value of the chip thermistor 13, or the time required to detect the heating temperature of the heater wire 11 increases. As a result, in the first comparative example there is a problem that the response speed of the temperature control of the heater wire 11 by the controller 19 is lowered.

Next, a heater device 102 of a second comparative example will be described.

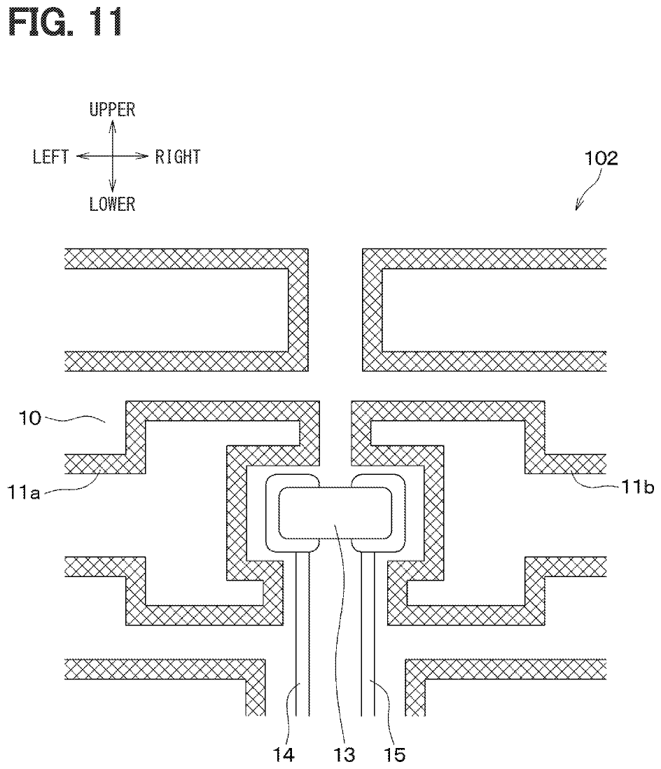

As shown in FIG. 11, the heater device 102 of the second comparative example also does not have the branch line 12. Instead, in the second comparative example, the heater wire 11 is extended and arranged around the chip thermistor 13. However, when the heater wire 11 is extended as in the second comparative example, the total length of the heater wire 11 is increased and the resistance value of the heater wire 11 is increased. Therefore, in the second comparative example, there arises a problem that the heating rate of the heat generating surface 2 becomes slow when the heater wire 11 is energized.

Compared to the heater device 101 of the first comparative example and the heater device 102 of the second comparative example, the heater device 1 of the first embodiment has the following effects.

(1) The heater device 1 of the first embodiment includes the branch line 12 extending from the heater wire 11. The branch line 12 has one end connected to the heater wire 11 and the other end extending around the chip thermistor 13 without being connected to the heater wire 11.

According to this configuration, when the heater wire 11 generates heat by energizing the heater wire 11, the heat is transmitted to the branch line 12. The heat of the branch line 12 raises the temperature of the chip thermistor 13. Therefore, even if there is a place where the distance between the heater wire 11 and the chip thermistor 13 is longer, by arranging the branch line 12 around the chip thermistor 13, it is possible to reduce the difference between the heating temperature of the heater wire 11 and the temperature of the chip thermistor 13. Therefore, the heater device 1 can improve the temperature detection accuracy of the heat generating surface 2 by the chip thermistor 13 and improve the response speed of the temperature control of the heater wire 11.

Further, in the heater device 1 of the first embodiment, since the branch line 12 branching from the heater wire 11 is provided around the chip thermistor 13, and there is no need to extend the heater wire 11, the total length of the heater wire 11 is not increased. Therefore, the resistance value of the heater wire 11 does not increase, and a decrease in the rate of temperature increase when the heater wire 11 is energized can be prevented.

(2) In the heater device 1 of the first embodiment, the distance Db between the branch line 12 and the chip thermistor 13 is shorter than the distance Dh between the heater wire 11 and the chip thermistor 13.

According to this configuration, the branch line 12 is arranged at a position closer than the distance Dh between the heater wire 11 and the chip thermistor 13. Therefore, even if there is a place where the heater wire 11 and the chip thermistor 13 are remote from each other, the temperature of the chip thermistor 13 can be raised by the heat of the branch line 12 branched from the heater wire 11. Therefore, the difference between the heating temperature of the heater wire 11 and the temperature of the chip thermistor 13 can be reduced.

(3) In the first embodiment, the heater wire 11 and the branch line 12 are continuously formed of the same material.

According to this configuration, heat can be efficiently transferred from the heater wire 11 to the branch line 12, and the temperature of the chip thermistor 13 can be raised by the heat of the branch line 12.

### Second Embodiment

A second embodiment will be described. The second embodiment is similar to the first embodiment except for the configuration of the heater wire 11 and the branch line 12 modified from the corresponding configuration of the first embodiment. Accordingly, only parts different from the corresponding parts of the first embodiment are herein described.

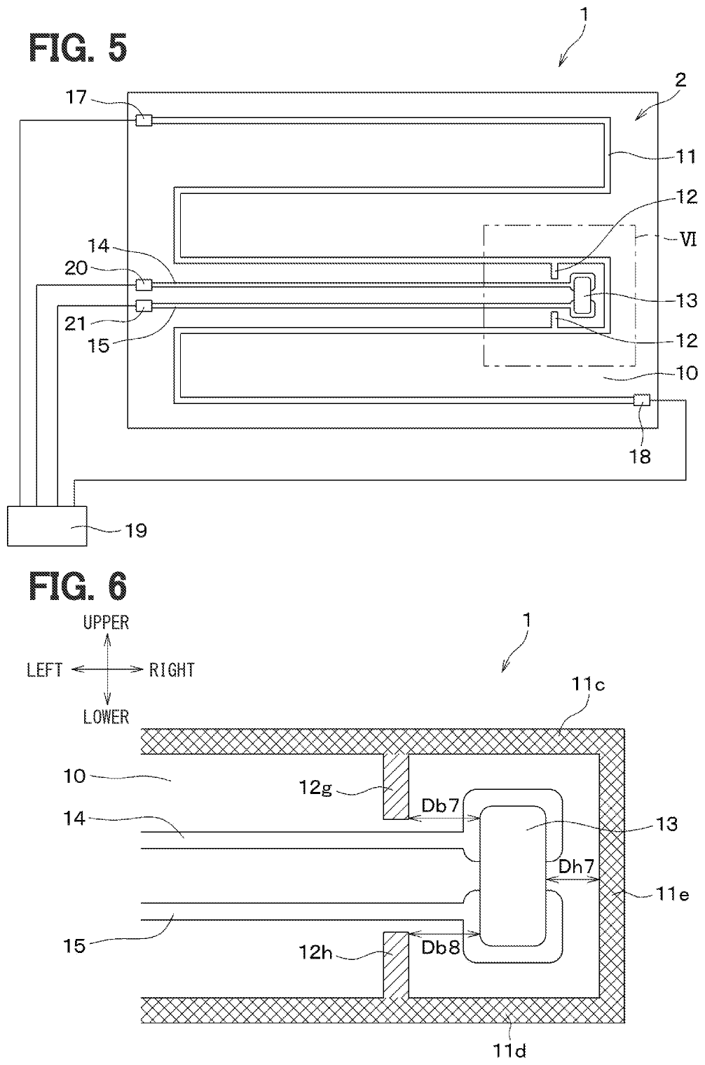

As shown in FIGS. 5 and 6, the heater device 1 of the second embodiment also includes the insulating base material 10, the heater wire 11, the branch line 12, the chip thermistor 13, the thermistor lines 14 and 15, the insulating layer, and the like. there is

In the second embodiment, for the sake of explanation, the plurality of branch lines 12 shown in FIG. 6 will be referred to as a seventh branch line 12g and an eighth branch line 12h. The seventh branch line 12g extends to approach one thermistor line 14 from the heater wire 11c arranged on the upper side of the paper surface of FIG. 6. The eighth branch line 12h extends to approach the other thermistor line 15 from the heater wire 11d arranged on the lower side of the paper surface of FIG. 6. When both the seventh branch line 12g and the eighth branch line 12h are viewed from a direction perpendicular to the extending direction of the branch lines 12g and 12h (that is, when viewed from the left and right direction of the paper surface of FIG. 6), both the seventh branch line 12g and the eighth branch line 12h extend to positions where the chip thermistor 13 and at least part of the branch lines 12g and 12h overlap.

In the second embodiment, part of the heater wire 11 is provided so as to surround the upper, right, and lower sides of the chip thermistor 13 in FIG. 6. The seventh branch line 12g and the eighth branch line 12h are provided on the left side of the chip thermistor 13 in FIG. 6. Therefore, in the second embodiment, the periphery of the chip thermistor 13 is surrounded by a part of the heater wire 11, the seventh branch line 12g, and the eighth branch line 12h.

Here, a distance between the heater wire 11 and the chip thermistor 13 is defined as Dh, and a distance between the branch line 12 and the chip thermistor 13 is defined as Db. Specifically, a distance between the heater wire 11e arranged on the right side of the paper surface of FIG. 6 and the right side surface of the chip thermistor 13 is defined as Dh7. On the other hand, a distance between the seventh branch line 12g and the chip thermistor 13 is defined as Db7, and a distance between the eighth branch line 12h and the chip thermistor 13 is defined as Db8.

At this time, all of the distances Db7 and Db8 between the seventh and eighth branch lines 12g and 12h and the chip thermistor 13 are two times or less the distance Dh7 between the heater wire 11e arranged on the right side of the paper surface of FIG. 6 and the right side surface of the chip thermistor 13. That is, in the second embodiment, a relationship of Db≤2×Dh is satisfied.

Also in the second embodiment, when a predetermined voltage is applied from the controller 19 to the terminal 17 of the heater wire 11 and a potential difference is generated between the terminals 17 and 18, current flows through the heater wire 11 and the heater wire 11 generates heat. The heat generated by the heater wire 11 is transferred to the branch line 12. As described above, in the second embodiment, part of the heater wire 11 is provided on the upper, right, and lower sides of the chip thermistor 13 in FIG. 6, and the seventh branch line 12g and the eighth branch line 12h are provided on the left side of the chip thermistor 13 in FIG. 6. Therefore, in the second embodiment, substantially the entire circumference of the chip thermistor 13 is heated by the heat of the heater wire 11, the seventh branch line 12g, and the eighth branch line 12h. Therefore, the difference between the heating temperature of the heater wire 11 and the temperature of the chip thermistor 13 becomes small. The controller 19 detects the temperature of the heat generating surface 2 based on changes in the resistance value of the chip thermistor 13, and based on the detected temperature, controls the energization of the heater wire 11 so that the heat generating surface 2 reaches a predetermined target temperature.

Here, a heater device 103 of a third comparative example will be described for comparison with the heater device 1 of the second embodiment described above.

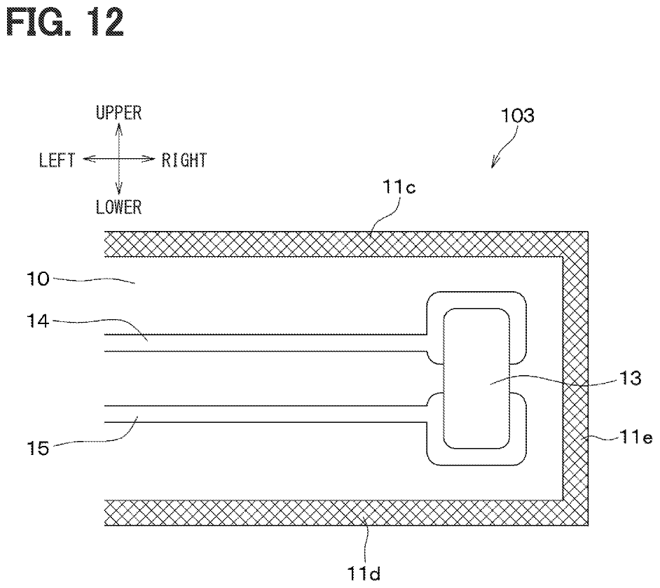

As shown in FIG. 12, the heater device 103 of the third comparative example does not have the branch line 12. Therefore, in the third comparative example, part of the heater wire 11 is provided so as to surround the upper, right and lower sides of the chip thermistor 13 in FIG. 6, neither the heater wire 11 nor the branch line 12 is provided on the left side of the chip thermistor 13 in FIG. 12.

In the heater device 103 of the third comparative example, when a predetermined voltage is applied from the controller 19 to the terminal 17 of the heater wire 11 and a potential difference is generated between the terminals 17 and 18, a current flows through the heater wire 11 and the heater wire 11 generates heat. At this time, in the third comparative example, although the temperatures on the upper side, the right side, and the lower side of the chip thermistor 13 in FIG. 12 are increased, the temperature rise on the left side of the chip thermistor 13 in FIG. 12 becomes small. Therefore, in the third comparative example, the difference between the heating temperature of the heater wire 11 and the temperature of the chip thermistor 13 is greater than that in the second embodiment. Therefore, in the third comparative example, the detection accuracy of the heating temperature of the heater wire 11 deteriorates due to the change in the resistance value of the chip thermistor 13, or the time required to detect the heating temperature of the heater wire 11 increases. As a result, in the third comparative example there is a problem that the response speed of the temperature control of the heater wire 11 by the controller 19 is lowered.

As compared to the heater device 103 of the third comparative example, the heater device 1 of the second embodiment has the following effects.

(1) The heater device 1 of the second embodiment is also provided with the branch line 12 extending from the heater wire 11 as in the first embodiment. The branch line 12 has one end connected to the heater wire 11 and the other end extending around the chip thermistor 13 without being connected to the heater wire 11. Therefore, even if there is a place where the distance between the heater wire 11 and the chip thermistor 13 is longer, by arranging the branch line 12 around the chip thermistor 13, it is possible to reduce the difference between the heating temperature of the heater wire 11 and the temperature of the chip thermistor 13. Therefore, the heater device 1 can improve the temperature detection accuracy of the heat generating surface 2 by the chip thermistor 13 and improve the response speed of the temperature control of the heater wire 11.

(2) In the heater device 1 of the second embodiment, the distance Db between the branch line 12 and the chip thermistor 13 is two times or less the distance Dh between the heater wire 11 and the chip thermistor 13.

According to this configuration, the branch line 12 can be arranged at a place where the temperature of the chip thermistor 13 can be raised by the heat of the branch line 12. Therefore, even if there is a place where the distance between the heater wire 11 and the chip thermistor 13 is longer, by arranging the branch line 12 around the chip thermistor 13, it is possible to reduce the difference between the heating temperature of the heater wire 11 and the temperature of the chip thermistor 13 due to the heat transferred from the branch line 12 to the chip thermistor 13.

As a modification of the second embodiment, although not shown, a relationship between the distance Db between the branch line 12 and the chip thermistor 13 and the distance Dh between the heater wire 11 and the chip thermistor 13 may satisfy a relationship of Db≤Dh. According to this configuration, it is possible to apply to the chip thermistor 13 from the branch line 12 an amount of heat equivalent to that applied to the chip thermistor 13 from the heater wire 11 arranged closest to the chip thermistor 13. Therefore, the difference between the heating temperature of the heater wire 11 and the temperature of the chip thermistor 13 can be made smaller.

### Third Embodiment

A third embodiment will be described. The third embodiment changes a part of structure of the branch line 12 with respect to the second embodiment.

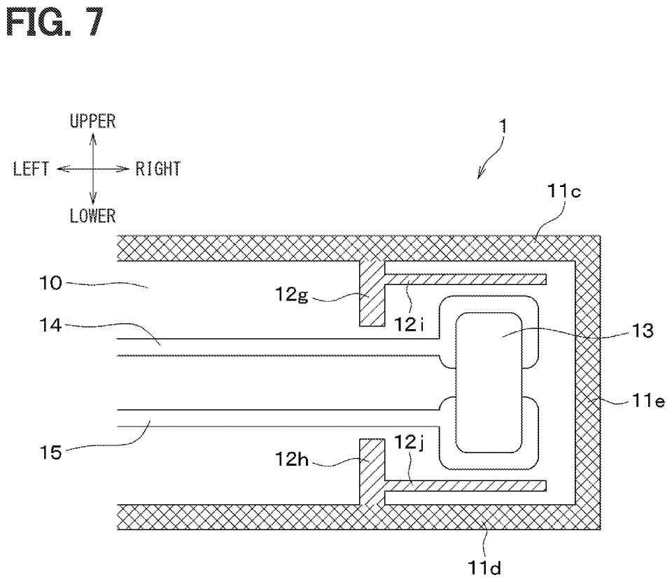

As shown in FIG. 7, the heater device 1 of the third embodiment includes a ninth branch line 12i extending along the upper surface of the chip thermistor 13 in FIG. 7 from the middle of the seventh branch line 12g. A tenth branch line 12j extending from the middle of the eighth branch line 12h along the lower surface of the chip thermistor 13 in FIG. 7. In the third embodiment, the periphery of the chip thermistor 13 is surrounded by part of the heater wire 11 and the seventh to tenth branch lines 12g to 12j.

In the third embodiment, in addition to the seventh and eighth branch lines 12g and 12h described in the second embodiment, the ninth and tenth branch lines 12i, 12j are provided between the upper and lower heater wires 11c and 11d and the chip thermistor 13. Thereby, in the third embodiment, it is possible to further reduce the difference between the heating temperature of the heater wire 11 and the temperature of the chip thermistor 13. Therefore, the heater device 1 of the third embodiment can further improve the temperature detection accuracy of the heat generating surface 2 by the chip thermistor 13 and improve the response speed of the temperature control of the heater wire 11.

### Fourth Embodiment

A fourth embodiment will be described. The fourth embodiment also changes a part of structure of the branch line 12 with respect to the second embodiment.

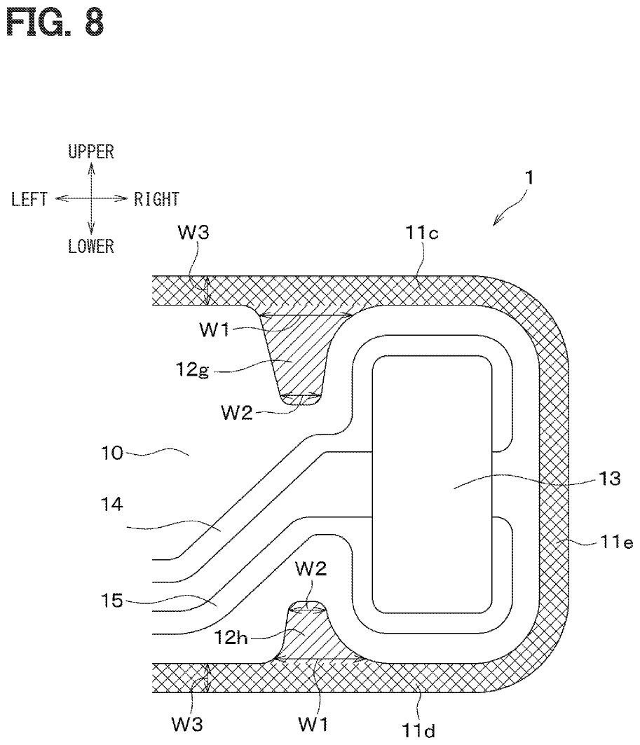

As shown in FIG. 8, the heater device 1 of the fourth embodiment also includes the insulating base material 10, the heater wire 11, the branch line 12, the chip thermistor 13, the thermistor lines 14 and 15, the insulating layer, and the like.

Also in the fourth embodiment, for the sake of explanation, the plurality of branch lines 12 shown in FIG. 8 are referred to as a seventh branch line 12g and an eighth branch line 12h. The seventh branch line 12g extends to approach one thermistor line 14 from the heater wire 11c arranged on the upper side of the paper surface of FIG. 8. The eighth branch line 12h extends to approach the other thermistor line 15 from the heater wire 11d arranged on the lower side of the paper surface of FIG. 8. When both the seventh branch line 12g and the eighth branch line 12h are viewed from a direction perpendicular to the extending direction of the branch lines 12g and 12h (that is, when viewed from the left and right direction of the paper surface of FIG. 8), both the seventh branch line 12g and the eighth branch line 12h extend to positions where the chip thermistor 13 and at least part of the branch lines 12g and 12h overlap. Also in the fourth embodiment, the periphery of the chip thermistor 13 is surrounded by part of the heater wire 11, the seventh branch line 12g, and the eighth branch line 12h.

In the fourth embodiment, a width of the portion of the seventh branch line 12g on the heater wire 11c side is defined as W1, a width of the end portion remote from the heater wire 11c of the seventh branch line 12g is defined as W2, and a width of the heater wire 11 is defined as W3. In the fourth embodiment, the heater wire 11c used when defining W1 and W2 for the seventh branch line 12g is a portion of the heater wire 11 to which the seventh branch line 12g is connected.

In the fourth embodiment, the seventh branch line 12g satisfies a relationship of W1≥W2. Also, a relationship of W1≥W3 is satisfied. Furthermore, a relationship of W2≥W3 is satisfied. The significance of defining the width of the seventh branch line 12g in this way will be described below.

First, by setting the width W1 of the portion of the seventh branch line 12g on the heater wire 11c side to be equal to or larger than the width W2 of the end portion of the seventh branch line 12g remote from the heater wire 11c (that is, a relationship of W1≥W2), the amount of heat transferred from the heater wire 11c to the seventh branch line 12g increases. Therefore, it is possible to increase the temperature of the seventh branch line 12g. Therefore, the heat generated by the heater wire 11c can be efficiently transferred to the chip thermistor 13 via the seventh branch line 12g.

Next, by setting the width W1 of the portion of the seventh branch line 12g on the heater wire 11c side to be equal to or larger than the width W3 of the heater wire 11c (that is, a relationship of W1≥W3), the amount of heat transferred from the heater wire 11c to the seventh branch line 12g increases. Therefore, it is possible to increase the temperature of the seventh branch line 12g. Therefore, the heat generated by the heater wire 11c can be efficiently transferred to the chip thermistor 13 via the seventh branch line 12g.

Furthermore, by setting the width W2 of the end portion of the seventh branch line 12g remote from the heater wire 11c to be equal to or larger than the width W3 of the heater wire 11c (that is, a relationship of W2≥W3), from the end portion of the seventh branch line 12g remote from the heater wire 11c, heat can be transmitted to the chip thermistor 13 over a wide range.

From the above three relationships, it can also be understood that the seventh branch line 12g has a relationship of W1≥W2≥W3. According to this configuration, by setting the width W1 of the portion of the seventh branch line 12g on the heater wire 11c side to be equal to or larger than the width W2 of the end portion of the seventh branch line 12g remote from the heater wire 11c, the amount of heat transferred from the heater wire 11c to the seventh branch line 12g increases. By setting the width W2 of the end portion of the seventh branch line 12g remote from the heater wire 11c to be equal to or larger than the width W3 of the heater wire 11c, from the end portion of the seventh branch line 12g remote from the heater wire 11c, heat can be transmitted to the chip thermistor 13 over a wide range.

The relationships among W1, W2, and W3 for the seventh branch line 12g described above can be defined similarly for the eighth branch line 12h. Even in this case, the eighth branch line 12h provides the same effects as those described for the seventh branch line 12g.

### Fifth Embodiment

A fifth embodiment will be described. The fifth embodiment also changes a part of structure of the branch line 12 with respect to the second embodiment.

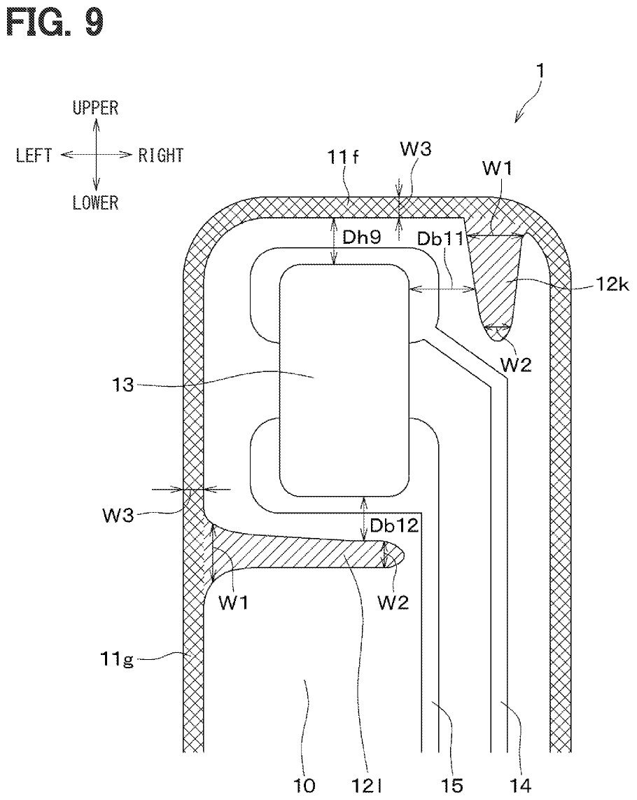

As shown in FIG. 9, the heater device 1 of the fifth embodiment also includes the insulating base material 10, the heater wire 11, the branch line 12, the chip thermistor 13, the thermistor lines 14 and 15, the insulating layer, and the like.

In the fifth embodiment, for the sake of explanation, the plurality of branch lines 12 shown in FIG. 9 will be referred to as an eleventh branch line 12k and a twelfth branch line 12h. The eleventh branch line 12k extends to approach one thermistor line 14 from the heater wire 11f arranged on the upper side of the paper surface of FIG. 9 along the right side surface of the chip thermistor 13 of the paper surface of FIG. 9. The twelfth branch line 12l extends to approach the other thermistor line 15 from the heater wire 11g arranged on the left side of the paper surface of FIG. 9 along the lower side surface of the chip thermistor 13 on the paper surface of FIG. 9.

When the eleventh branch line 12k is viewed from a direction perpendicular to the extending direction of the eleventh branch line 12k (that is, when viewed from the left and right direction of the paper surface of FIG. 9), the eleventh branch line 12k extends to a position where the chip thermistor 13 and at least part of the branch line 12k overlap. When the twelfth branch line 12l is viewed from a direction perpendicular to the extending direction of the twelfth branch line 12k (that is, when viewed from the left and right direction of the paper surface of FIG. 9), the twelfth branch line 12k extends to a position where the chip thermistor 13 and at least part of the branch line 12l overlap.

In the fifth embodiment, part of the heater wire 11 is provided so as to surround the upper and left sides of the chip thermistor 13 in FIG. 9. The eleventh branch line 12k is provided on the right side of the chip thermistor 13 in FIG. 9. The twelfth branch line 12l is provided in the chip thermistor 13 on the lower side in FIG. 9. Therefore, in the fifth embodiment, the periphery of the chip thermistor 13 is surrounded by a part of the heater wire 11, the eleventh branch line 12k, and the twelfth branch line 12l.

Here, a distance between the heater wire 11 and the chip thermistor 13 is defined as Dh, and a distance between the branch line 12 and the chip thermistor 13 is defined as Db. Specifically, the distance between the heater wire 11f arranged on the upper side of the paper surface of FIG. 9 and the upper surface of the chip thermistor 13 is defined as Dh9.

On the other hand, a distance between the eleventh branch line 12k and the chip thermistor 13 is defined as Db11, and a distance between the twelfth branch line 12l and the chip thermistor 13 is defined as Db12.

At this time, all of the distances Db11 and Db12 between the eleventh and twelfth branch lines 12k and 12l and the chip thermistor 13 are twice times or less the distance Dh9 between the heater wire 11f arranged on the upper side of the paper surface of FIG. 9. That is, in the fifth embodiment, a relationship of Db≤2×Dh is satisfied. According to this configuration, the branch line 12 can be arranged at a place where the temperature of the chip thermistor 13 can be raised by the heat of the branch line 12. Therefore, even if there is a place where the distance between the heater wire 11 and the chip thermistor 13 is longer, by arranging the branch line 12 around the chip thermistor 13, it is possible to reduce the difference between the heating temperature of the heater wire 11 and the temperature of the chip thermistor 13 due to the heat transferred from the branch line 12 to the chip thermistor 13.

Also in the fifth embodiment, the branch line 12 and the heater wire 11 have the relationship of W1≥W2, W1≥W3, W2≥W3, and W1≥W2≥W3. According to this configuration, by setting the width W1 of the portion of the branch line 12 on the heater wire 11c side to be equal to or larger than the width W2 of the end portion of the branch line 12 remote from the heater wire 11 (that is, a relationship of W1≥W2), the amount of heat transferred from the heater wire 11 to the branch line 12 increases. Further, by setting the width W1 of the portion of the branch line 12 on the heater wire 11 side to be equal to or larger than the width W3 of the heater wire 11 (that is, a relationship of W1≥W3), the amount of heat transferred from the heater wire 11 to the branch line 12 increases. By setting the width W2 of the end portion of the branch line 12 remote from the heater wire 11 to be equal to or larger than the width W3 of the heater wire 11 (that is, a relationship of W2≥W3), from the end portion of the branch line 12 remote from the heater wire 11, heat can be transmitted to the chip thermistor 13 over a wide range.

Also in the fifth embodiment, when a predetermined voltage is applied from the controller 19 to the terminal 17 of the heater wire 11 and a potential difference is generated between the terminals 17 and 18, current flows through the heater wire 11 and the heater wire 11 generates heat. At this time, the heat generated by the heater wire 11 is transferred to the branch line 12. In the fifth embodiment, substantially the entire circumference of the chip thermistor 13 is heated by the heat of the heater wire 11, the eleventh branch line 12k, and the twelfth branch line 12l. Therefore, in the fifth embodiment, as in the above-described first to fourth embodiments, by arranging the branch line 12 around the chip thermistor 13, it is possible to reduce the difference between the heating temperature of the heater wire 11 and the temperature of the chip thermistor 13. Therefore, the heater device 1 can improve the temperature detection accuracy of the heat generating surface 2 by the chip thermistor 13 and improve the response speed of the temperature control of the heater wire 11.

### Other Embodiments

(1) In each of the embodiments described above, the chip thermistor 13 is used as an example of the temperature detection element, but the temperature detection element is not limited to this configuration. Various elements such as a thermocouple and a semiconductor sensor may be used as the temperature detection element.

(2) In addition, in each of the embodiments described above, the shape of the chip thermistor 13 as a temperature detection element is substantially rectangular, but the shape thereof is not limited to this shape. The shape of the temperature detection element can be various shapes such as circular, elliptical, and polygonal.

(3) In the fourth and fifth embodiments described above, the branch line 12 and the heater wire 11 have the relationship of W1≥W2, W1≥W3, W2≥W3, and W1≥W2≥W3, but the relationships thereof are not limited to these relationships. The branch line 12 and the heater wire 11 may have the relationship of W1>W2, W1>W3, W2>W3, and W1>W2>W3. This configuration can obtain a greater effect than the branch line and the heater wire having the relationship of W1=W2, W1=W3, W2=W3, and W1=W2=W3.

(4) The branch line 12 and the heater wire 11 may have the dimensional relationships of W1=W2, W1=W3, W2=W3, and W1=W2=W3 that does not include manufacturing tolerances, if necessary. Such dimensional relationships may be, for example, the dimensional relationship of W1≥1.1×W2, W1≥1.1×W3, W2≥1.1×W3, and W1≥1.1×W2≥1.1×W3.

The present disclosure is not limited to the above-described embodiments, and can be appropriately modified. The above-described embodiments are not independent of each other, and can be appropriately combined together except when the combination is obviously impossible. The constituent element(s) of each of the above embodiments is/are not necessarily essential unless it is specifically stated that the constituent element(s) is/are essential in the above embodiment, or unless the constituent element(s) is/are obviously essential in principle. A quantity, a value, an amount, a range, or the like referred to in the description of the embodiments described above is not necessarily limited to such a specific value, amount, range or the like unless it is specifically described as essential or understood as being essential in principle. Furthermore, a shape, positional relationship or the like of a structural element, which is referred to in the embodiments described above, is not limited to such a shape, positional relationship or the like, unless it is specifically described or obviously necessary to be limited in principle.

What is claimed is:

1. A heater device, comprising:
an insulating base material;
a heater wire that is provided on the insulating base material, forms a path through which current flows when energized, and generates heat when energized;
a temperature detection element provided on the insulating base material and having electrical characteristics that change according to temperature;
a line provided on the insulating base material and electrically connected to the temperature detection element; and
a branch line provided on the insulating base material, having one end connected to the heater wire and the other end not connected to the heater wire, and extending around the temperature detection element;
wherein
a width of a portion of the branch line on the heater wire side is defined as W1,
a width of an end portion of the branch line remote from the heater wire is defined as W2, and
a relationship of W1≥W2 is satisfied.

2. The heater device according to claim 1, wherein
a width of the heater wire is defined as W3, and
a relationship of W1≥W3 is satisfied.

3. The heater device according to claim 1, wherein
a width of the heater wire is defined as W3, and
a relationship of W2≥W3 is satisfied.

4. A heater device, comprising:
an insulating base material;
a heater wire that is provided on the insulating base material, forms a path through which current flows when energized, and generates heat when energized;
a temperature detection element provided on the insulating base material and having electrical characteristics that change according to temperature;
a line provided on the insulating base material and electrically connected to the temperature detection element; and
a branch line provided on the insulating base material, having one end connected to the heater wire and the other end not connected to the heater wire, and extending around the temperature detection element;
wherein
a width of a portion of the branch line on the heater wire side is defined as W1,
a width of an end portion of the branch line remote from the heater wire is defined as W2,
a width of the heater wire is defined as W3, and
a relationship of W1≥W2≥W3 is satisfied.

5. The heater device according to claim 1, wherein
a distance between the branch line and the temperature detection element is defined as Db,
a distance between the heater wire and the temperature detection element is defined as Dh, and
a relationship of Db≤2×Dh is satisfied.

6. A heater device, comprising:
an insulating base material;
a heater wire that is provided on the insulating base material, forms a path through which current flows when energized, and generates heat when energized;
a temperature detection element provided on the insulating base material and having electrical characteristics that change according to temperature;
a line provided on the insulating base material and electrically connected to the temperature detection element; and
a branch line provided on the insulating base material, having one end connected to the heater wire and the other end not connected to the heater wire, and extending around the temperature detection element;
wherein
the heater wire and the branch line are continuously formed of the same material.

7. The heater device according to claim 4, wherein
a distance between the branch line and the temperature detection element is defined as Db,
a distance between the heater wire and the temperature detection element is defined as Dh, and
a relationship of Db≤2×Dh is satisfied.
